(19) United States
(12) Patent Application Publication
(10) Pub. No.: US 2013/0123991 A1
(43) Pub. Date: May 16, 2013

(54) THERMOSTAT AND IRRIGATION CONTROLLER WITH REMOVABLE USER INTERFACE

(71) Applicant: Robert Charles Richmond, Yucaipa, CA (US)

(72) Inventor: Robert Charles Richmond, Yucaipa, CA (US)

(21) Appl. No.: 13/481,315

(22) Filed: May 25, 2012

Related U.S. Application Data
(60) Provisional application No. 61/560,587, filed on Nov. 16, 2011.

(51) Int. Cl. G05B 15/02; G05D 7/06; G05D 23/19

(52) U.S. Cl. 700/276

(57) ABSTRACT

Improvements in a thermostat for HVAC control and an irrigation controller for sprinkler control are constructed each with a Base Unit and a removable User Interface Unit. The dual-function Base Unit is configurable for use as either a thermostat or an irrigation controller. The Base Unit has a connector for connection to a separate User Interface (UI) Unit. The separate UI Unit has a display, controls, and I/O Connector for connection to a Base Unit or an external computer. The UI Unit adaptively operates as a thermostat interface or irrigation interface, as is appropriate for the configuration of a connected Base Unit. The UI Unit can be connected via its I/O Connector to a PC, tablet PC, or smart phone for configuration of operational control settings using application software. The configuration settings are transferred from a UI Unit to a Base Unit upon connection via the I/O Connector.

### CROSS REFERENCE TO RELATED APPLICATION

This application claims the benefit of Provisional Application Ser. No. 61/560,587 filed Nov. 16, 2011 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a user interface that is used with both an irrigation controller base and a separate HVAC base. More particularly a thermostat for HVAC control or an irrigation controller for sprinkler control is constructed which is comprised of a separate base unit and a removable user interface unit. In one form, a dual-function base unit is constructed such that it can be configured for use either as a thermostat or as an irrigation controller. The base unit has an input/output connector for optional connection to a separate user interface (UI) Unit. The separate UI unit has a user display, user controls, and an input/output connector for connection to either a base unit or to an external computer.

2. Description of Related Art Including Information Disclosed Under 37 CFR 1.97 and 1.98

Thermostats for HVAC control are becoming increasingly sophisticated. Energy-saving thermostats must be accurately programmed by the user with weekly day and time schedules of different temperatures. In addition there may be many other settings needed, such as setting the date and time, adjusting for daylight saving time, and other HVAC operational parameters. Furthermore, it may be necessary to change the schedules from time to time to reflect seasonal changes and/or user daily routine changes. It is desirable therefore to provide a user interface which simplifies and makes it convenient for the user to make changes, and reduces the probability of a data entry error by the user. It is also desirable to provide a means for the user to easily view the schedule and other settings in an intuitive form. Thermostat displays are limited by the available display and control area and cost. Thermostats are permanently attached to the wall in what is often an inconvenient location and height, and lighting may be marginal. Most thermostats have complex and non-intuitive operational procedures which require the user to learn and remember. Irrigation controllers suffer from similar problems with respect to programming watering schedules, making seasonal changes, etc.

Some thermostats have been constructed which can be removed from the wall to allow more convenient user access. This is sometimes referred to as “armchair programming”. Because the electrical contacts to the HVAC equipment must carry relatively high current loads, the electrical connector is typically difficult to pull apart and put back together when the entire thermostat is removed. During the time the thermostat is removed for armchair programming, there is no HVAC control. Irrigation controllers have also been constructed with armchair programming capabilities, with similar limitations.

Some thermostats use graphic display screens with backlights in order to provide a more user-friendly graphical interface. Such displays require additional software, memory, and processing power to operate, compared to more minimal displays. These displays can add significant cost to the thermostat. Most of the time they simply display the temperature and mode of operation, and the more complex configuration functions are infrequently activated, so the capabilities of the user interface are not well utilized. Users are generally more interested in a lower-cost commodity thermostat rather than a higher-cost thermostat with unnecessary features, given that they perform the same functions. However, simple low-cost displays generally do not have a user-friendly means for entering and viewing schedules and other settings.

A number of patents and or publications have been made that provide separate control for irrigation or HVAC, while other devices control both components from a single interface. Examples of patents and publications that try to address this problem are identified and discussed below.

U.S. Pat. No. 5,544,036 issued on Aug. 6, 1996 to Robert J. Brown et al. discloses an Energy Management and Home Automation System. The system uses commands to control the HVAC unit in a home. While this patent discloses control of the HVAC system, it does not control an irrigation system, and further the interface for the HVAC system stays connected to the HVAC control unit.

U.S. Pat. No. 7,668,532 issued on Feb. 23, 2010 to Charles G. Shamoon et al and discloses a Ubiquitous Connectivity and control System for Remote Locations. The ubiquitous control device allows for remote control of various household devices but controls these devices as a wireless device and the each of the devices is operated from a separate single module.

U.S. Publication Number 2010/0083356 was published on Apr. 1, 2010 to Andrew Steckley et al. and discloses a System and Method for Intelligent Automated Remote Management of Electromechanical Devices. The control system allows for wireless or wired control of various devices. The devices are operated from a separate single module.

What is needed is a removable user interface (UI) unit that adaptively operates as a thermostat interface or as an irrigation interface, as is appropriate for the configuration of the Base Unit to which it is connected. The UI Unit can also be connected via its I/O Connector to a PC, tablet PC, or smart phone for configuration of operational control settings using application software. The configuration settings are transferred from a UI Unit to a Base Unit upon making connection via the I/O Connector. Various versions of UI Units can be constructed with alternate features and capabilities, all of which can be connected interchangeably to Base Units. In one form, a single unified serial message protocol is used for communication to the Base Unit, the UI Unit, any external computer, and any optional radio inside either unit, thereby simplifying the implementation. All of the limitations discussed above can be addressed with the Thermostat and Irrigation Controller with Removable User Interface. In addition, other advantages and benefits are provided.

### BRIEF SUMMARY OF THE INVENTION

It is an object of the thermostat and irrigation controller with removable user interface to provide two independently functioning units, each in its own enclosure. One is called the “Base Unit” and the other is called the “UI Unit”. Each has distinct hardware and firmware. A programmable thermostat and an irrigation controller operate similarly. They both switch loads on and off at predetermined times for predetermined periods. There are also some operational differences; a thermostat changes its temperature set points and an irrigation controller initiates timed watering sequences according to a programmed schedule. A dual-function device which could perform either function would offer advantages. Since many homes have both a thermostat and an irrigation controller, such a dual-function device could potentially be built in larger quantities than equivalent single-function devices, resulting in cost savings due to manufacturing economies of scale. The users' task to learn and remember how to operate both devices could be simplified if both have similar user interfaces.

It is an object of the thermostat and irrigation controller with removable user interface that the Base Unit hardware can act either as a thermostat or as an irrigation controller with appropriate firmware. The Base Unit is normally permanently attached to a wall and/or in a protective enclosure.

It is an object of the thermostat and irrigation controller with removable user interface that the UI Unit hardware can act either as a thermostat control panel or as an irrigation control panel with appropriate firmware. The UI Unit is normally, but not necessarily, attached (docked) to the Base Unit. Multiple interchangeable UI Unit versions are possible. The functionality of each version depends on the desired cost, features, and capabilities. In many cases multiple thermostats and/or irrigation controllers may be controlled by a single group of authorized users. There could be a considerable cost savings if a single user interface could be transported and shared between multiple base units.

It is an object of the thermostat and irrigation controller with removable user interface that the UI Unit is connected to the Base Unit with an I/O connector so they can be either connected or separated. When attached, a conventional user control interface is provided by the UI Unit. When the UI Unit is removed from the Base Unit, convenient “armchair programming” of new settings is possible by the user without the need to remove the Base Unit. The new settings are stored in the UI Unit. The Base Unit continues to function with its previous settings while the UI Unit is removed. Often it is desired to allow only authorized users to make changes to thermostat settings. Thermostat covers are sometimes used to prevent access to the controls, but these are easily defeated and may even invite tampering. A password can be used to limit access, but this further complicates the thermostat's user interface, and must be recorded elsewhere to prevent being forgotten. For irrigation controllers, it may be desired to allow changes to the irrigation schedule to be made only by authorized personnel such as landscape maintenance personnel.

It is an object of the thermostat and irrigation controller with removable user interface that any new or changed configuration settings stored in the UI Unit are copied to the Base Unit when the UI Unit is re-attached.

It is an object of the thermostat and irrigation controller with removable user interface that the configuration settings stored in the UI Unit can be copied to multiple Base Units. Configuration settings for both types of Base Units can be stored in a single UI Unit. The appropriate settings are transferred when docked to a Base Unit. In some cases two or more thermostats use the same or similar configuration settings and schedules. It would be convenient to have a means to easily copy the same settings and schedule to multiple units.

It is an object of the thermostat and irrigation controller with removable user interface that the UI Unit can automatically adapt its function appropriately when docked to either a thermostat or irrigation controller. A single control panel can therefore be used for both purposes on two or more different Base Units.

It is an object of the thermostat and irrigation controller with removable user interface that the I/O connector on the UI Unit connects to either a Base Unit or a computer. The UI Unit can be connected to a PC, tablet PC, or smart phone via its I/O connector. This allows a software application to be used for user-friendly configuration. The configuration settings are stored within the UI Unit.

It is an object of the thermostat and irrigation controller with removable user interface that the I/O connector serial message protocol is the same as that used by the Base Unit's radio (if present). The Base Unit microprocessor therefore only needs to support a single message protocol for both communication functions.

It is an object of the thermostat and irrigation controller with removable user interface that the UI Unit can be equipped to function as a “portable comfort control” (thermostat remote control) when removed from the Base Unit. When docked to the Base Unit, it acts as a conventional thermostat user control panel.

It is an object of the thermostat and irrigation controller with removable user interface that the UI Unit can be upgraded to a different appearance and/or functionality without removal of the Base Unit, eliminating the need for professional or complicated installation. It may be desired to upgrade the functionality of a thermostat or irrigation controller after installation. For example, some utilities offer thermostats which can be controlled by the utility during peak load periods, or can display current utility rate information, etc. A new thermostat may be required for such an upgrade. An irrigation controller may be similarly linked to a remote control weather station. A user may wish to upgrade a minimal user interface to a more deluxe interface if his personal preferences change. The user may even desire the color and/or style of the thermostat to be changed. Current thermostats and irrigation controllers generally have no possibility of such upgrades without changing the entire unit, often requiring a professional installation.

It is an object of the thermostat and irrigation controller with removable user interface that the UI Unit can be removed to prevent tampering with the thermostat or irrigation controller configuration settings.

It is an object of the thermostat and irrigation controller with removable user interface that a UI Unit can be used which has limited or no capability to change configuration settings or schedules, preventing casual users from tampering. However, the UI Unit can be connected to an application program via its I/O connector or wirelessly for changes made by authorized users.

It is an object of the thermostat and irrigation controller with removable user interface that different UI Units can be used interchangeably on the same Base Unit. A UI Unit with the ability to change configuration settings can be kept for use only by authorized users. A UI Unit with limited or no capability to change configuration settings can be otherwise left in place on the Base Unit for unauthorized users to prevent tampering. The original Installation of a thermostat may require control settings for the type of HVAC equipment being controlled. There could be equipment malfunction if these settings are changed at a later date. It is therefore important to have a means to prevent certain critical settings from being inadvertently changed.

It is an object of the thermostat and irrigation controller with removable user interface that a UI Unit with the ability to change installation-specific settings can be kept for use only by professional installers. A UI Unit with limited or no capability to change installation-specific settings can be otherwise left in place on the Base Unit for users to prevent equipment damage.

It is an object of the thermostat and irrigation controller with removable user interface that a UI Unit could be used to additionally act as a remote control for other wireless devices such as a security system or smoke alarms. Many buildings include a security alarm system. Such a system often uses a dedicated control panel for arming and disarming the alarm system. It would be desirable to eliminate the cost and unsightly appearance of a dedicated security control panel with a common control panel for use with multiple devices. Smoke alarms should be tested frequently, and alarms should be easy to silence. Carbon monoxide levels should be readily viewable. A common control panel for multiple devices could potentially perform those functions.

It is an object of the thermostat and irrigation controller with removable user interface that a Base Unit can be remotely controlled by an external computer, tablet PC, smart phone, or from the Internet. This is accomplished using wireless communication with the Base Unit's radio (if present).

It is another object of the thermostat and irrigation controller with removable user interface that a single UI Unit could be used to control one or more thermostats and one or more irrigation controllers. This is accomplished if a radio is present (either in the Base Unit or UI Unit) and the user selects the device to be controlled. If the UI unit is docked to a Base Unit, it communicates wirelessly with the other radio-equipped unit(s).

It is another object of the Thermostat and Irrigation Controller with Removable User Interface that a thermostat can sense temperature at the use's actual location not at the thermostat. A “personal comfort control” is a unit which the user can move to the desired point for improved comfort. Such a unit is costly. It would be desirable to provide this capability at lower cost.

It is another object of the thermostat and irrigation controller with removable user interface to provide emergency control of an HVAC system in the event of a hazardous condition. This can be accomplished if a radio is present either in the base unit or user interface unit which can communicate with smoke alarms. Upon reception of a hazardous condition message from a smoke alarm, the HVAC equipment is controlled by the present invention to mitigate the hazard. For example, the HVAC could be turned off in the event of a fire to prevent the spread of smoke. The HVAC fan could be turned on to ventilate excessive carbon monoxide.

It is another object of the thermostat and irrigation controller with removable user interface to indicate the location of a hazardous condition alarm. Upon reception of a hazardous condition message from a hazardous condition detector such as a smoke alarm, the location(s) of the hazardous condition(s) of the hazardous condition(s) are displayed on the User Interface unit.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a table of how the hardware components are used in each configuration.

FIG. 2 shows a view of the base unit.

FIG. 3 shows removable User Interface Unit connected to a PC.

FIG. 4 shows the user interface unit connected to a base unit with the display showing functions for controlling HVAC.

FIG. 5 shows a table with different versions of UI Units.

FIG. 6 shows the user interface in a configuration for HVAC.

FIG. 7 shows the user interface in a configuration for an irrigation controller.

FIG. 8 shows the Base Unit and UI Unit Electrical Block Diagram, Low Cost Version.

FIG. 9 shows Base Unit and UI Unit Electrical Block Diagram, Full Featured Version.

FIG. 10 shows a Low Cost UI Unit Example.

FIG. 11 shows a Comfort Control UI Unit Example.

FIG. 12 shows a Utility Version UI Unit Example.

### DETAILED DESCRIPTION OF THE INVENTION

Two independently functioning units are defined, each in its own enclosure. One is called the “Base Unit” and the other is called the “UI Unit”. Each has distinct hardware and firmware.

Base Unit

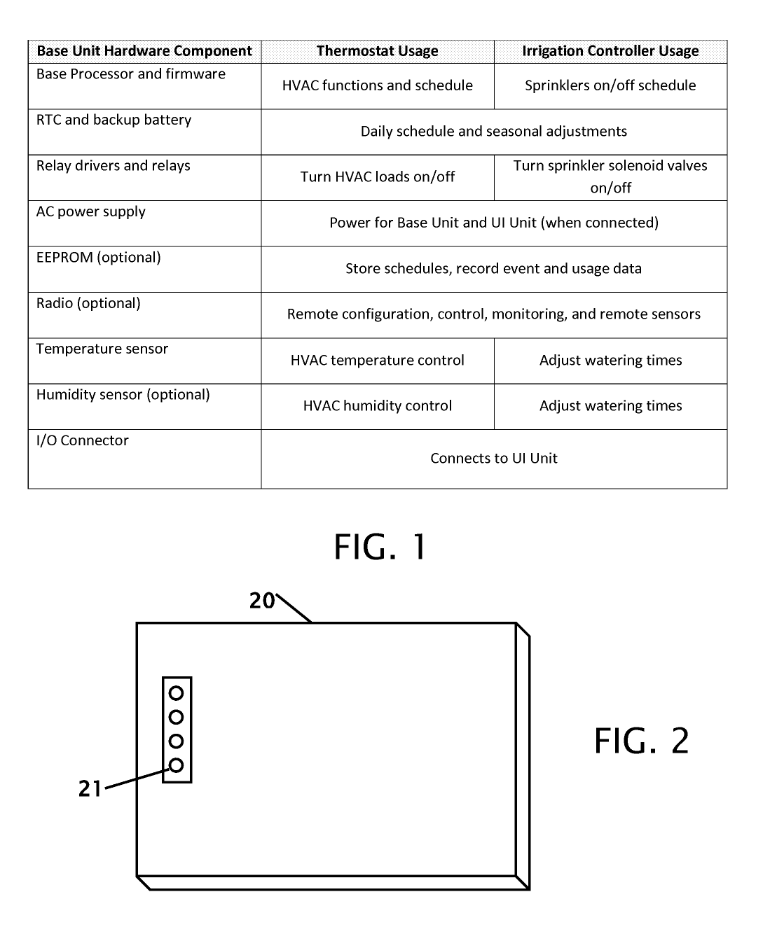

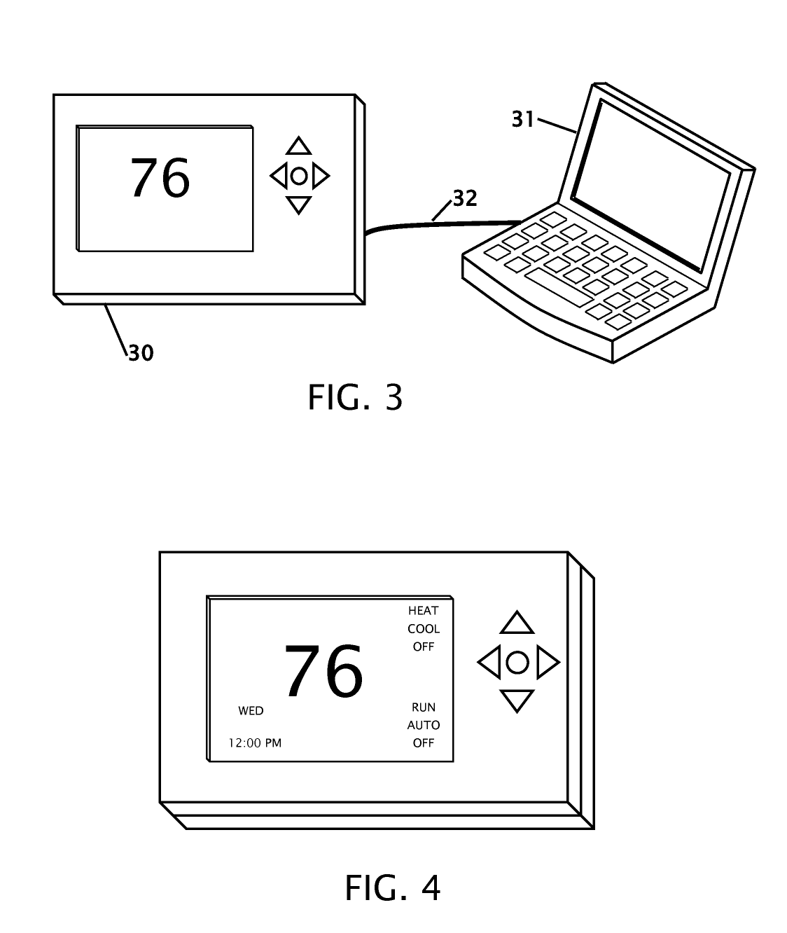

A Base Unit is used to control the HVAC equipment (in the case of a thermostat) or the sprinkler valve solenoids (in the case of an irrigation controller). The Base Unit is permanently attached to a wall or protective enclosure. It typically contains the components listed FIG. 1. The Base Unit is configured by firmware to operate either as a thermostat or as an irrigation controller. The table in FIG. 1 shows how the hardware components are used in each configuration.

FIG. 2 shows a view of the base unit 20. The Base Unit 20 does not have or require a user interface. It can optionally be controlled via its radio, if present. Messages are sent between the Base Processor 65 and the wireless remote control device via the radio. The messages allow full control of configuration, control, and monitoring. The radio also receives messages from remote sensors. In the case of the thermostat configuration, remote sensors include occupancy sensors and hazardous condition sensors. In the case of the irrigation controller configuration, remote sensors include environmental sensors of temperature, rainfall, etc. The radio hardware communicates with the Base Processor 65 internally by transferring the messages in a serial digital format.

The wireless remote control can be from a PC, tablet PC, or smart phone. These devices can provide a user-friendly graphical interface application program, simplifying the user's tasks. A single application program could be used, for example, to wirelessly configure, control, and monitor all the thermostats and irrigation controllers in a building. Additionally, a simpler remote control unit could be used to perform basic control functions.

The Base Unit 20 has an I/O Connector 21 for connection to a User Interface Unit. This connector is used to serially transfer messages to and from the User Interface Unit for configuration, control, and monitoring of the Base Unit. The I/O Connector message (payload) format is the same as that used by the radio, as described above. The Base Processor 65 therefore can be controlled by a single message protocol from either the radio or the User Interface Unit. The Base Processor 65 does not need to support two different control protocols.

The I/O Connector 21, at a minimum, provides power and two-way message communication from the Base Unit to the UI Unit. The power connection is used to power the UI Unit and also to charge its battery 71 (if present).

Messages can perform functions, such as loading a schedule, which are the same for both uses of the Base Unit. Other messages are specific to the Base Unit firmware. If the Base Unit is running thermostat firmware, it will respond to thermostat-specific commands, such a temperature up/down. If the Base Unit is running irrigation firmware, it responds to irrigation-specific commands, such as start/stop a sprinkler zone.

The Base Unit 20 includes at least a means of mechanical attachment for the UI unit. It can also include a mechanical locking mechanism which can be engaged to make it difficult to remove the User Interface Unit if desired.

Configurable Base Unit

The majority of thermostats are powered by 24 VAC 61. The majority of irrigation controllers are also powered by 24 VAC 61. For most cases, this simplifies the task of construction a Base Unit 20 which can perform either function. Also, most thermostats and most irrigation controllers use relays 62 to switch similar types of loads.

User Interface Unit

A removable User Interface Unit 30 can optionally be connected to the Base Unit 20. It attaches (docks) to the Base Unit 20 securely and can be locked in place for permanent use if desired. Different versions of UI Units can be used, with buttons 41, LEDs 77, and display 74 or 66, depending on the desired features and cost. The Base Unit 20 continues to perform its intended control function whether a UI Unit is attached or not.

A single UI Unit 30 can be used adaptively as both a thermostat and an irrigation controller. The UI Unit communicates automatically with the Base Unit 20 to determine its firmware type. If the Base Unit 20 is running thermostat firmware, the UI Unit 30 acts as a thermostat control panel. If the Base Unit 20 is running irrigation firmware, the UI Unit 30 acts as an irrigation control panel.

The UI Unit stores in its non-volatile memory 76 a copy of all the configuration and schedule information used by the Base Unit. Configuration information and schedules can be entered directly by the user or by connecting the UI Unit to a computer.

For computer configuration, the UI Unit 30 is removed from the Base Unit 20 and then connected to a PC 31, tablet PC, or smart phone via the I/O Connector. One end of a cable 32 plugs into the I/O Connector 21, the other end plugs into the controlling device 31. A graphic application program can then be used to change the settings or schedule stored in the User Interface Unit 30. The UI Unit 30 is then removed from the cable 32 and returned to the Base Unit 20. Upon reattachment, the UI Unit 30 proceeds to transfer its settings to the Base Unit 20. Thereafter the new settings and schedule are stored in both the UI Unit 30 and the Base Unit 20.

A single UI Unit 30 can store the settings and schedules for both a thermostat and an irrigation controller. When the UI Unit 30 is attached to the Base Unit 20, it adaptively uses the appropriate settings required by the base unit firmware. Therefore a single UI Unit 30 can be transported between a thermostat and an irrigation controller and act appropriately for each function.

A single UI Unit 30 which has been configured by a computer 31 as herein described and can be used to transfer configuration information and schedules into multiple Base Units 20 simply by attaching the UI Unit 30 to the additional Base Units. Additionally, configuration information and schedules can be copied from a Base Unit 20 into a UI Unit 30 by selecting a user option on the UI Unit 30. This allows Base Units 20 to be “cloned” from a source Base Unit 20.

Adaptive User Interface

There are many ways to construct a user interface such that it can provide all the necessary user controls for both a thermostat and an irrigation controller. One contemplated user interface is shown in FIG. 4. This example uses an LCD display 74. Another contemplated example could be a menu-driven dot matrix text display 66. The displayed items and the button 41 function change as is appropriate for the Base Unit 20 to which it is attached. If not attached to a Base Unit 20, an operational mode could be made available for selection by the user to change the function of the UI Unit 30.

UI Unit Versions

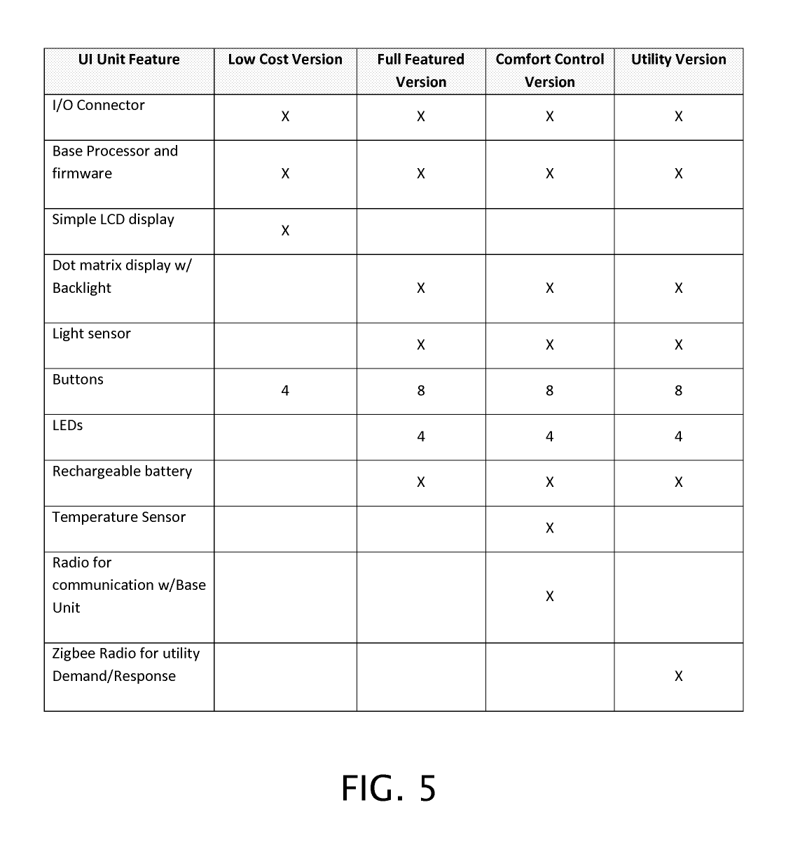

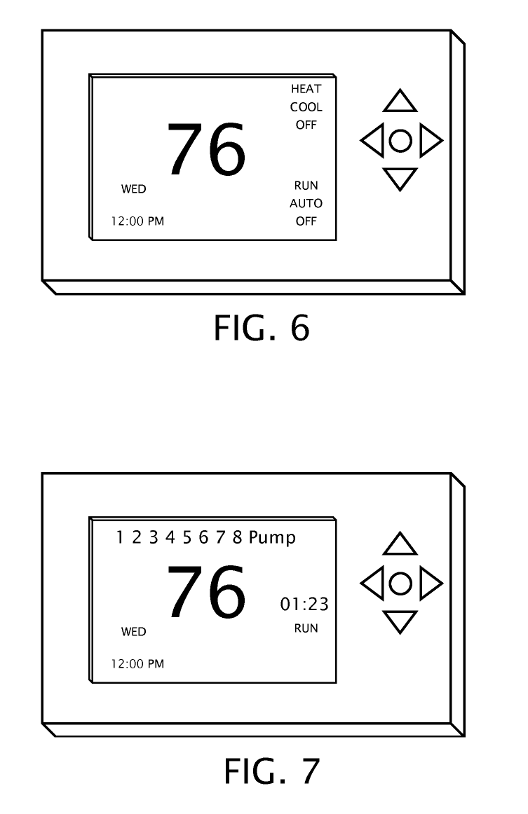

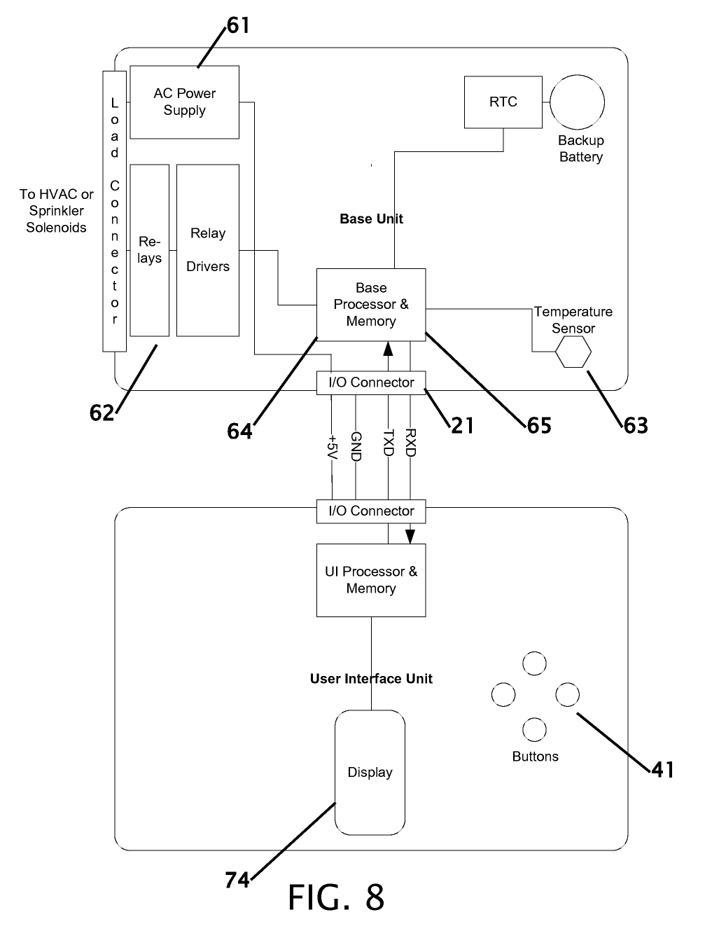

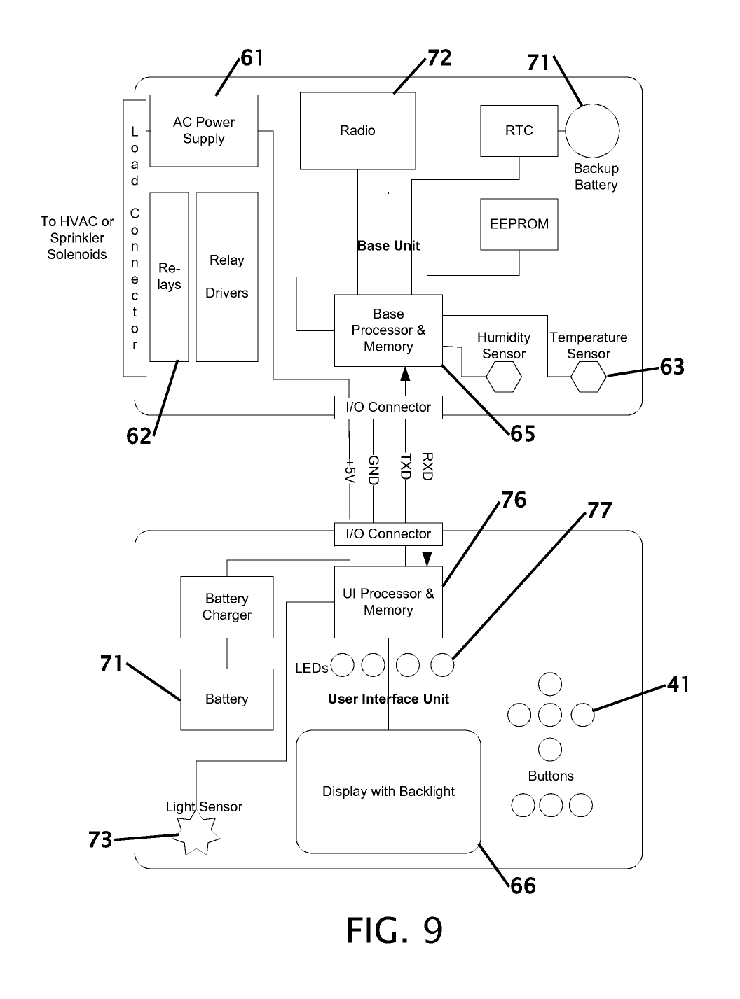

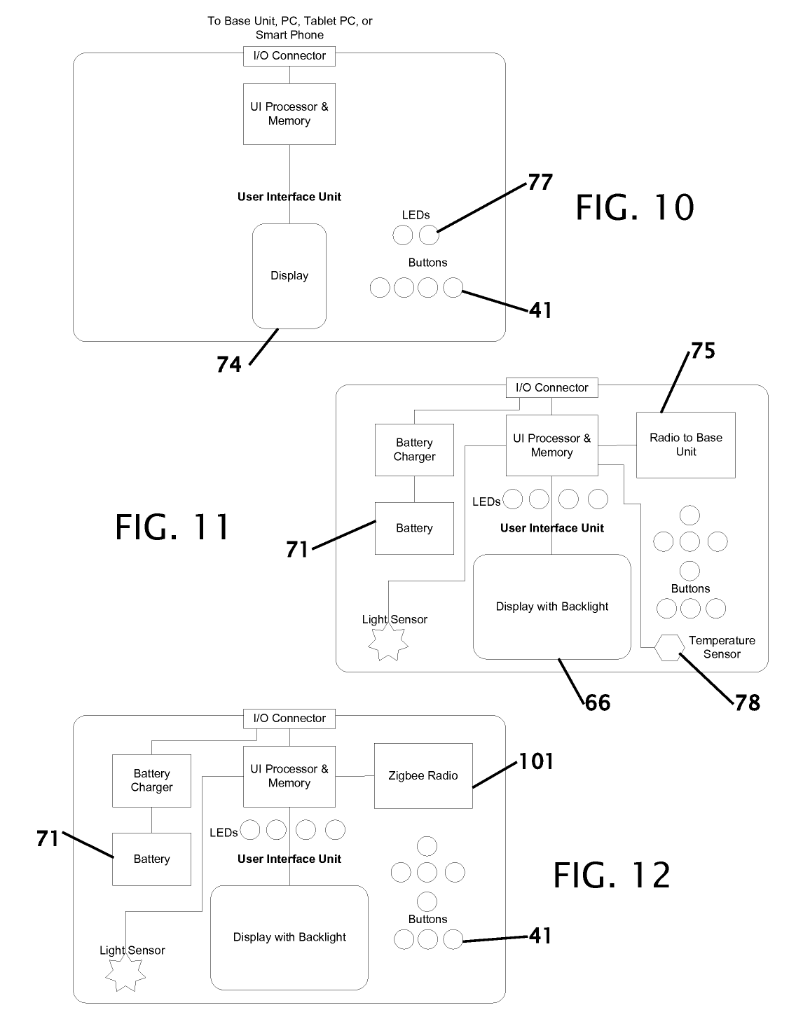

FIG. 5 shows a table with typical examples of different versions of UI Units 30 with different costs and features. FIG. 6 shows the user interface in a configuration for HVAC and FIG. 7 shows the user interface in a configuration for an irrigation controller. FIG. 8 shows the Base Unit and UI Unit Electrical Block Diagram, Low Cost Version, FIG. 9 shows Base Unit and UI Unit Electrical Block Diagram, Full Featured Version, FIG. 10 shows a Low Cost UI Unit Example, FIG. 11 shows a Comfort Control UI Unit Example and FIG. 12 shows a Utility Version UI Unit Example.

It may be desired to minimize cost yet retain a full set of features. This can be done by providing a minimal user interface, for example, with no user controls for programming a schedule or changing configuration settings. In this case, if a radio 72 is present in the Base Unit 20, schedules may be programmed wirelessly with a PC 31, tablet PC, or smart phone. Alternatively, a full featured UI Unit 30 could be temporarily attached by authorized users to make such changes, and a minimal UI Unit 30 otherwise attached for unauthorized users. In yet another example, there could be a version which changes installation-specific settings for use only by professional installers.

A full-featured example is also illustrated. It uses a more expensive display 66 with a menu-driven user interface, allowing schedules to be directly programmed as well as additional user capabilities. Backlight brightness is controlled by an ambient light sensor 73. It has a battery 71 for “armchair programming”.

This version could also be used as a remote control for wireless devices. For example, it could be used to arm or disarm a wireless security system. It could monitor, control, and test wireless smoke alarms.

Another version can act as a “personal comfort control” when removed from a thermostat. It includes a temperature sensor 78 which reports the local temperature back to the thermostat via a compatible radio 75. This version also allows the user to remotely view and monitor the temperature, as well as change the settings. It could also be used as a remote control for other wireless devices, as described above.

A “utility version” includes an additional radio for communication with a utility company for Demand/Response and load shedding applications. The radio might be a Zigbee 101 or other suitable wireless format. This UI Unit version can be used to upgrade the thermostats of users who subscribe to the service without requiring a new thermostat or professional installation. In the case of an irrigation controller, the additional radio may receive weather-based watering schedules from a remote transmitter.

UI Unit Used as a Remote Control

The UI Unit 30 can function as a wireless remote control for other devices. If the Base Unit 20 has a radio, the UI Unit 30 can act as a remote control when the UI Unit 30 is attached to the Base Unit 20. If the UI Unit 30 has a radio 75, it can act as a remote control whether attached or removed from the Base Unit 20.

Possible uses include displaying the location of a smoke alarm, displaying carbon monoxide levels, testing and/or silencing alarms, arming or disarming an intruder alarm, sending configuration settings to remote devices, turning lights on or off, etc.

Thus, specific embodiments of a thermostat and irrigation controller with removable user interface have been disclosed. It should be apparent, however, to those skilled in the art that many more modifications besides those described are possible without departing from the inventive concepts herein. The inventive subject matter, therefore, is not to be restricted except in the spirit of the appended claims.

1. A thermostat and an irrigation controller each with removable user interface comprising:
a thermostat for control of an HVAC system and an irrigation controller for control of a sprinkler system comprised of a base unit and a user interface unit each in its own enclosure;
said base unit is attached to a wall or protective enclosure and which has an input/output connector for message communication with a user interface unit;
said user interface unit is attachable to said base unit for message communication via an input/output connector;
wherein operational control settings are stored in said base unit;
wherein said base unit is capable of performing its control functions according to its operational control settings whether or not said user interface unit is attached;
wherein said user interface unit contains a display and controls for changes to one or more operational control settings by a user, and
wherein changes made by said user to said operational control settings are transferred from said user interface unit to said base unit while said user interface unit is attached to said base unit, thereby providing said operational control settings for said base unit.

2. The thermostat and an irrigation controller each with removable user interface from claim 1 wherein said operational control settings are stored in both said base unit and said user interface unit;
said operational control settings in said user interface unit are changeable when said user interface unit is removed from said base unit and said operational control settings are transferred from said user interface unit into said base unit upon attachment of the said user interface unit to base unit, thereby providing said operational control settings for the base unit.

3. The thermostat and an irrigation controller each with removable user interface from claim 1 wherein said base unit is configured with firmware and/or switches and/or jumpers to function either as a thermostat or irrigation controller.

4. The thermostat and an irrigation controller each with removable user interface from claim 1 wherein said user interface unit is configured with firmware and/or switches and/or jumpers to function either as a thermostat or irrigation controller user interface.

5. The thermostat and an irrigation controller each with removable user interface from claim 4 wherein said user interface unit adaptively functions either as a thermostat controller user interface or an irrigation controller user interface depending on functions of said base unit to which said user interface unit is attached.

6. The thermostat and an irrigation controller each with removable user interface from claim 2 wherein said user interface unit simultaneously stores operational control settings for both a thermostat and an irrigation controller.

7. The thermostat and an irrigation controller each with removable user interface from claim 2 wherein said user interface unit connects and communicates with a PC, tablet PC, and/or smart phone via its said input/output connector for the purpose of changing its operational control settings.

8. The thermostat and an irrigation controller each with removable user interface from claim 1 wherein different versions of said user interface unit with specific features and or appearance can be used interchangeably on a said base unit.

9. The thermostat and an irrigation controller each with removable user interface from claim 1 wherein said user interface unit further includes a radio and can be used as a wireless remote control for other base units and/or compatible wireless devices.

10. The thermostat and an irrigation controller each with removable user interface from claim 1 wherein said base unit and said user interface unit further includes a radio in said base unit and can be used as a wireless remote control for one or more other base units and/or compatible wireless devices when said user interface unit is attached.

11. The thermostat and an irrigation controller each with removable user interface from claim 9 wherein said user interface unit further uses a same message protocol for said input/output connector and said radio.

12. The thermostat and an irrigation controller each with removable user interface from claim 10 wherein said base unit further uses a same message protocol for said input/output connector and said radio.

13. The thermostat and an irrigation controller each with removable user interface from claim 1 wherein said user interface unit and said base unit further includes a radio in both said user interface unit and said base unit and a temperature sensor in said user interface unit such that said user interface unit provides remote thermostat temperature and control.

14. The thermostat and an irrigation controller each with removable user interface from claim 1 wherein said user interface unit copies and stores historical performance information from said base unit when said user interface unit is attached to said base unit.

15. The thermostat and an irrigation controller each with removable user interface from claim 14 wherein said user interface unit connects and communicates with a PC, tablet PC, and/or smart phone via said input/output connector for sending said historical performance information retrieved from said base unit.

16. The thermostat and an irrigation controller each with removable user interface from claim 1 wherein said user interface unit further includes a radio and displays operational status from one or more wireless hazardous condition detectors, including at least one location of hazardous conditions including smoke, or combustion detection and carbon monoxide level.

17. The thermostat and an irrigation controller each with removable user interface from claim 1 wherein said base unit further includes a radio that is used to display operational status from one or more wireless hazardous condition detectors, including at least one location of hazardous conditions including smoke, or combustion detection and carbon monoxide level.

18. The thermostat and an irrigation controller each with removable user interface from claim 1 wherein said base unit and said user interface unit comprises a thermostat which further includes a radio in said base unit and/or in said user interface unit that operates said HVAC system in order to mitigate a hazardous condition upon wireless notification of smoke or combustion detection.

19. The thermostat and an irrigation controller each with removable user interface from claim 1 that receives rainfall information for purposes of suspending or enabling irrigation.

20. The thermostat and an irrigation controller each with removable user interface from claim 1 wherein said base unit communicates with a PC, tablet PC, and/or smart phone via a wireless communications link for purposes of configuration, control, and/or monitoring.

21. The thermostat and an irrigation controller each with removable user interface from claim 1 wherein said base unit communicates with the Internet via a wireless communications link for purposes of configuration, control, and/or monitoring.
